(19) United States
(12) Patent Application Publication
(10) Pub. No.: US 2006/0198300 A1
(43) Pub. Date: Sep. 7, 2006

(54) Multi-channel TCP connections with congestion feedback for video/audio data transmission

(76) Inventors: Chia-Hsin Li, San Jose, CA (US); Steve Nelson, San Jose, CA (US)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/073,063

(22) Filed: Mar. 3, 2005

(51) Int. Cl. H04L 12/26; H04J 3/14; H04J 1/16; H04L 1/00

(52) U.S. Cl. 370/229; 370/248

(57) ABSTRACT

A method of transmitting data over a communication network has congestion feedback. The method includes a sending application such as a video conferencing program opening a plurality of TCP connections. The sending application provides data packets to an encapsulation module, which appends a TCP header to each data packet. For each encapsulated data packet, a packet sender module selects the least congested of the plurality of TCP connections for transmitting the packet. A packet capture library taps into the network stack prior to the TCP driver to calculate the available window size reflecting a degree of congestion for each of the plurality of TCP connections. A monitor module monitors the plurality of TCP connections, and provides the congestion information to the packet sender module.

### BACKGROUND OF THE INVENTION

The present invention relates generally to the transmission of information across the Internet, and more specifically to methods, systems, and apparatus for rapid, real-time transmission of information across the Internet and within networks and networked systems.

Many Internet based applications require real-time transmission and exchange of data for effective implementation. By way of example, H.323 Internet video conferencing protocol provides rapid, real time data exchange to present video and audio data for participants in local and remote settings. Typically, to realize the benefits of necessary real-time data exchange, data is transmitted over unreliable User Datagram Protocol/Internet Protocol (UDP/IP, or simply UDP). The advantage of using the unreliable UDP over the reliable Transmission Control Protocol (TCP, also TCP/IP) is primarily an advantage of speed for real-time applications that does not require reliable data transmission. UDP has less overhead since it does not transmit packet acknowledgement, packet verification, packet re-transmission requests, etc. In real time media transmission and play-back, such transmissions and verification processes negatively impact the system performance.

TCP is the dominant transport layer protocol of the current Internet(s). TCP maintains the highest degree of reliability by ensuring all data is received, received in the correct order, and that the data received is accurate and consistent with the data that was transmitted. In many applications, such reliability is paramount for effective data transmission.

It would be desirable if video and audio streams could be carried over TCP connections because TCP is widely accepted by most industrial and consumer firewalls. TCP streams are also known to be friendlier to network security than UDP streams.

However, it is well recognized that current TCP implementations are not ideally suited for delivering video and audio streams. For example, TCP connections can introduce significant delay and throughput variations in the delivery of data. The design goal of TCP is to provide a reliable network connection as opposed to real-time and constant-flow network connections. Accordingly, the throughput of a typical TCP connection varies according to the network packet-delivering situation.

The dilemma is that if UDP is used to deliver audio and video, the streams are very likely to be blocked by firewalls. However, if TCP is used to deliver audio and video streams, the result is stuttering video and audio. The stuttering video and audio occurs when there is data packet loss. The TCP receiver will wait and hold all the following packets until the lost packet is resent and received. When the lost packet is resent and arrives, all the held packets are delivered to the application at once. This causes the stall-and-fast-forward symptom when using TCP as the delivering channel for audio and video streams.

In view of the foregoing, what is needed is a method and system for TCP connections that minimize or eliminate the risk of the stall-and-fast-forward symptom when a packet is lost, and that communicate videoconference data through existing firewalls.

### SUMMARY OF THE INVENTION

Broadly speaking, the present invention fills these needs by the deployment of multiple TCP connections with network congestion feedback from the TCP/IP driver to reduce risk of the stall-and-fast-forward symptom when a packet is lost. The present invention can be implemented in numerous ways, including as a system, a method, or a computer readable media. Several embodiments of the present invention are described below.

In one embodiment, a method of transmitting data over a communication network is provided. The method includes opening a plurality of Transmission Control Protocol (TCP) connections. Each TCP connection is opened by an application having data to transmit. The method further includes forming data packets to transmit the data, and appending a TCP header to a data packet. The method then provides for selecting one of the TCP connections for transmitting the data packet, and transmitting the data packet over the selected TCP connection.

In another embodiment, a method of processing data for transmission over a data network is provided. The method provides for opening a plurality of Transmission Control Protocol (TCP) connections for transmitting data, and for forming a plurality of initial data packets of data to be transmitted over a data network. Each one of the initial data packets is encapsulated with a TCP header to become one of a plurality of transmission data packets. Next, the method provides for selecting one of the TCP connections for transmitting data for each of the transmission data packets. Each transmission data packet is sent through its selected TCP connection to a network driver for transmission over the data network. Each transmission data packet is examined to determine a state of congestion of each one of the TCP connections.

In a further embodiment, a computer readable medium having program instructions for transmitting data over a communication network is provided. The computer readable medium includes program instructions for opening a plurality of Transmission Control Protocol (TCP) connections. Each of the TCP connections is opened by an application having data to transmit. The computer readable medium further provides program instructions for forming data packets to transmit the data, and program instructions for appending a TCP header to a data packet. Additionally, the computer readable medium includes program instructions for selecting one of the TCP connections for transmitting the data packet, and program instructions for transmitting the data packet over the selected TCP connection.

In yet another embodiment, an integrated circuit chip for establishing data exchange between computing systems is provided. The integrated circuit chip provides logic for opening a plurality of Transmission. Control Protocol (TCP) connections for transmitting data packets. Also included is logic for forming data packets containing audio and video data for transmission. The integrated circuit chip also includes logic for appending TCP headers to the data packets, and logic for selecting one of the TCP connections for transmitting a data packet having an appended TCP header. Finally, the integrated circuit chip includes logic for transmitting the data packet having the appended TCP header over the selected TCP connection.

Advantages of the invention will become apparent from the following detailed description, taken in conjunction with the accompanying drawings, illustrating by way of example the principles of the invention.

### BRIEF DESCRIPTION OF THE DRAWINGS

The accompanying drawings, which are incorporated in and constitute part of this specification, illustrate exemplary embodiments of the invention and together with the description serve to explain the principles of the invention.

FIG. 1 is a high level system diagram of multi-channel TCP connections with congestion feedback for audio and video packet delivery in accordance with one embodiment of the present invention.

FIG. 2 schematically illustrates the route or conduit of TCP data transmission.

FIG. 3 schematically illustrates a plurality of TCP connections providing a plurality of routes or conduits for TCP data transmission.

FIG. 4 is a schematic of sender-side operations for data transmission in accordance with one embodiment of the present invention.

FIG. 5 illustrates the function of packet capture library in accordance with one embodiment of the present invention.

FIG. 6 is a flow chart diagram illustrating the method operations for data transmission utilizing multiple TCP channels in accordance with one embodiment of the present invention.

### DETAILED DESCRIPTION OF THE PREFERRED EMBODIMENTS

An invention for a method and system for data transmission in which multiple TCP connections are opened and in which congestion feedback from the TCP/IP driver is provided. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

As an overview, embodiments of the present invention generally provide for multiple TCP connections with congestion feedback for data transmission, including video and audio data. When, for example, a video conferencing application is launched, the application will open multiple TCP connections, and use a packet-capturing library to monitor the packet activities beneath the TCP driver stack. The packet-capturing library provides the capability to calculate the TCP window for each connection.

At the sender's side, when a TCP available window size (also known as usable window size) decreases, it generally indicates that the connection may be stalled. As generally accepted, and used herein, the TCP available window size is relative to the acknowledged sequence number. Data packets are generally transmitted with an assigned or determined sequence number (SEQ) and acknowledgement number (ACK), which are defined to be within a set range. When the SEQ reaches the upper limit of the range, numbering re-starts at the lower limit of the range. The available window size is determined by the total number of bytes in the window size, less the number of bytes not yet acknowledged. As the number of un-acknowledged bytes increases, the available window size decreases, indicating a possible stalled connection. There may be lost packets and the receiver has requested packet resend, or is waiting for the packet to be resent. If such a TCP connection is encountered, the sender should avoid use of that channel for sending further video and audio data because it is very likely to be stalled at the receiver's end. Rather, the TCP connection having the greatest or largest available window size should be selected to send the next video or audio packet. Such a connection should represent a clean TCP connection through which the receiver is not waiting for a lost packet or waiting for a resend packet from the sender.

In accordance with embodiments of the present invention, when the sender has a packet to send, the sender will evaluate its available TCP connections and select the TCP connection with the maximum TCP available window size. If a packet is lost during transmission, succeeding packets will not be stalled. Such subsequent packets will be transmitted via any one of the other TCP connections. The chance for all the TCP connections to stall is very small.

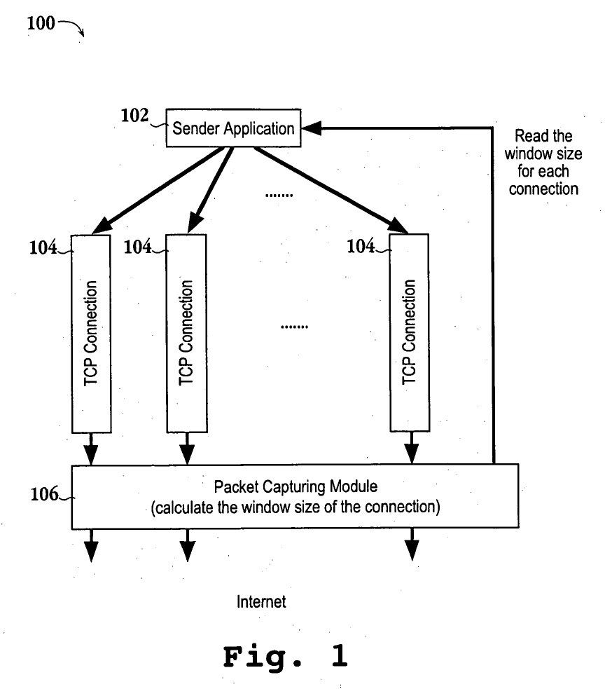

FIG. 1 is a high level system diagram 100 of multi-channel TCP connections with congestion feedback for audio and video packet delivery in accordance with one embodiment of the present invention. When sender application 102 is launched, executed, or otherwise activated to enable data packet transmission of audio and video data, sender application 102 opens more than one, and up to a plurality, of TCP connections 104. In one embodiment, data packets transmitted via TCP connections 104 are examined by packet capturing module 106, which determines the available window size for data packets at each of the more than one, and up to a plurality, of TCP connections 104. In one embodiment of the present invention, packet capturing module 106 calculates the available window size of each TCP connection 104 to enable sender application 102 to select the most appropriate TCP connection 104 for data transmission.

It should be appreciated that sender application 102 can be any application used to transmit or stream audio and video data. Examples include internet video conferencing applications such as WebEx Meeting.

As is known, a typical internet video conferencing application is configured to open multiple UDP connections for the exchange of audio and video data. As described in the Background, UDP is optimal for audio and video data, but the modern firewall environment has severely limited, if not eliminated, the ability to transmit UDP across networks or over the Internet. In co-pending U.S. patent application Ser. No. 10/681,732, filed Oct. 8, 2003, and entitled “CONNECTIONLESS TCP/IP DATA EXCHANGE,” a method and system is described in which data packets, e.g., UDP data packets, are encapsulated in an inventive TCP header, enabling transmission of the encapsulated packets via a TCP connection. The data packets, transmitted across networks or over the Internet via a TCP connection, are received by a receiving application which removes the inventive TCP header, and then processed as the original data packets. Co-pending U.S. patent application Ser. No. 10/681,732, assigned to the same assignee as is the present application, is incorporated herein by reference for all purposes.

As is known, a TCP connection is essentially defined by an IP address and IP port pair. That is to say, an IP address and port of a sender and an IP address and port of a receiver define a connection, channel, or conduit (hereinafter referred to as conduit) to enable the exchange of data packets. A receiver, for example, may receive a plurality of data packets from a sender, forward those received packets to a receiving application, and then assemble and distribute the received data to effect the transmitted communication as text, audio, video, etc.

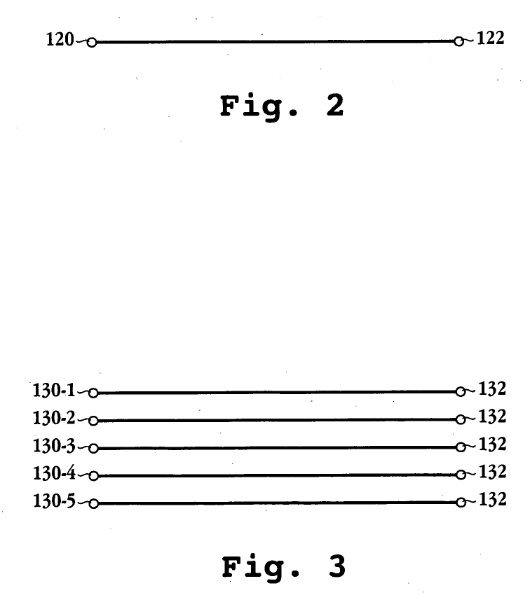

FIG. 2 schematically illustrates the conduit of TCP data transmission. A sender TCP IP address and port 120 define a source of data transmission, and a receiver TCP IP address and port 122 define a destination for data transmission. Data of any type, e.g., audio data, text, images, video data, etc., is formatted into data packets and transmitted from the sender TCP IP address and port 120 to the receiver TCP IP address and port 122. Once received at the receiver TCP IP address and port 122, individual data packets are verified, unpacked, assembled, and interpreted as the transmitted audio data, text, images, video data, etc. A plurality of data packets, often containing disparate types of data, are therefore processed at sender TCP IP address and port 120, transmitted to receiver TCP IP address and port 122, and then verified, assembled, forwarded to an appropriate interpreting application, etc.

In accordance with TCP protocol, the received data packets are verified to ensure all data is received, all data is received in the correct order, and that the data received is accurate and consistent with the data that was transmitted. As described above, this process can introduce significant delay when, e.g., packets are dropped leading to a receiver time-out, request for re-transmission, and re-transmission of packets, etc.

Embodiments of the present invention provide for a plurality of TCP connections for data exchange that might typically be routed over a single TCP connection. In other words, embodiments of the present invention open a plurality of TCP connections to provide a plurality of conduits, routes, channels, etc., for data exchange. The plurality of TCP connections are well suited for the transmission of audio and video data, minimizing or eliminating the stall and fast forward symptom as described above. It should be appreciated that multiple TCP connections in accordance with embodiments of the present invention do not increase the speed of data transmission. One reason for this is that operating multiple TCP connections increases the system over-head, and so requires more system resources. Therefore, overall through-put is not increased. Rather, constant data transmission is maintained.

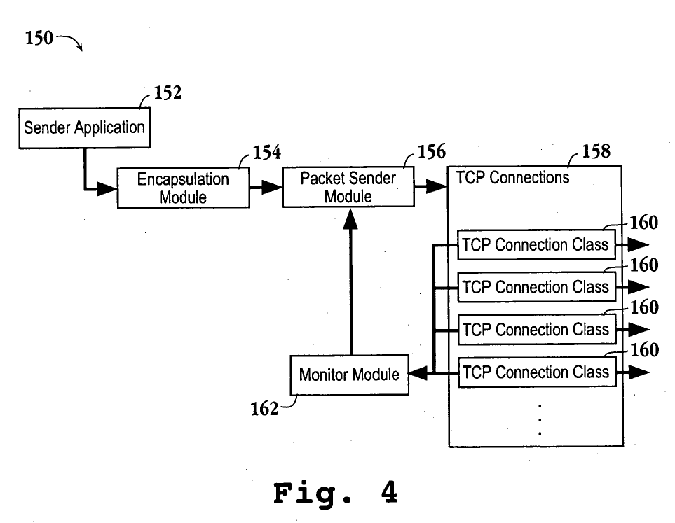

FIG. 3 schematically illustrates a plurality of TCP connections providing a plurality of routes or conduits for TCP data transmission. A sender TCP IP address and port 130-1-130-5 define a source of data transmission, and a receiver TCP IP address and port 132 define a destination for data transmission. As is known, the sender application can open a different or unique TCP IP address and port 130-1-130-5 for each TCP connection, each with the same destination or receiver TCP IP address and port 132, thereby defining unique TCP connections. In one embodiment, the receiver TCP IP address and port includes port 80 for HTTP transmissions, and used for TCP tunneling data. Data of any type that does not require reliable transmission, e.g., audio data, video data, market price update data, etc., is formatted into data packets and transmitted from a sender TCP IP address and port 130-1-130-5 to the receiver TCP IP address and port 132. Once received at the receiver TCP IP address and port 132, individual data packets are once again verified, unpacked, assembled, and interpreted as the transmitted audio data, text, images, video data, etc., regardless of the number of connections through which the data packets were transmitted.

Multiple TCP connections, as illustrated in FIG. 3, increase the likelihood of constant data flow which significantly increases the quality of real-time audio and video transmissions. If a packet is dropped at one TCP connection, stalling transmission by time-out, request for re-transmission, re-transmission, etc., the remaining TCP connections can continue data packet transmissions. In one embodiment, the number of TCP connections can range between two TCP connections and ten TCP connections. In one embodiment, the number of TCP connections is at least five TCP connections.

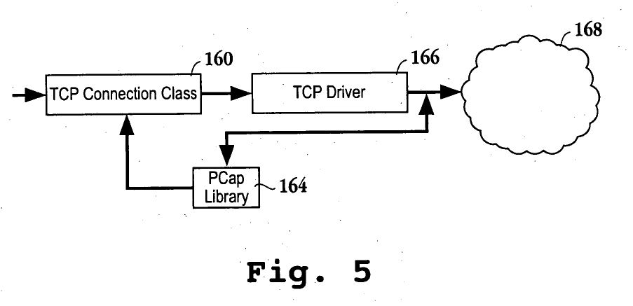

Embodiments of the present invention are ideally implemented to transmit constant flow, real-time data such as audio and video data. Of course, there are numerous other situations in which the present invention will greatly enhance data transmission. FIG. 4 is a schematic 150 of sender-side operations for data transmission in accordance with one embodiment of the present invention. A sender application 152, e.g., a video conferencing application, provides data for transmission. Data for transmission might include real-time audio and video data, and the sender application 152 would typically open a plurality of both TCP and UDP connections to transmit data. In accordance with embodiments of the present invention, however, data is first sent to an encapsulation module 154. Encapsulation module 154 packages the data packets as TCP packets with TCP headers according to standard TCP protocol. In other words, the data is packaged as a TCP data packet even if the sender application would ordinarily transmit the data over a UDP connection. In one embodiment, the TCP header is stateful, and fully compliant with TCP protocol.

In co-pending U.S. patent application Ser. No. 10/990,274, filed on Nov. 16, 2004, and entitled “METHOD AND APPARATUS FOR TUNNELING DATA USING A SINGLE SIMULATED STATEFUL TCP CONNECTION,” a method and system was described in which data packets, e.g., UDP data packets, are tunneled through a single HTTP port in order to pass through a firewall. Embodiments of the present invention can further extend the method and system described in co-pending U.S. patent application Ser. No. 10/990,274, to provide for multiple TCP connections which are fully TCP compliant, as described in greater detail below. Co-pending U.S. patent application Ser. No. 10/990,274, assigned to the same assignee as is the present application, is incorporated herein by reference for all purposes.

Returning to FIG. 4, once the data has been encapsulated in encapsulation module 154, the data is processed by packet sender module 156. In one embodiment of the invention, packet sender module 156 selects and sends each data packet to one of a plurality of TCP connections 158. In schematic 150, TCP connections 158 contain a plurality of TCP connection classes 160 representing the plurality of TCP connections opened for data transmission in accordance with embodiments of the present invention. In order to determine the best TCP connection class 160 to which to send a data packet, monitor module 162 is provided to monitor a data packet “queue” for each TCP connection class 160, as is described in greater detail below. The monitor module 162 provides the data queue information to the packet sender module 156, which then sends data packets to a TCP connection class for transmission.

In one embodiment of the invention, monitor module 162 evaluates a data packet queue for each TCP connection class 160 by examining the available window size for each data packet transmitted at each of the plurality of TCP connection classes 160. In accordance with standard TCP protocol, available window size can be used to measure data flow. As available window size decreases, potential data loss, or delay in data transmission, is indicated. In one embodiment, when the available window size drops to zero, data transmission stalls, the sender much cease sending data packets, and data flow essentially stops until such time as lost or dropped packets are recovered, re-transmitted, acknowledged, etc.

Embodiments of the present invention utilize a packet capture library to determine or monitor the available window size of each data packet, from each TCP connection class 160. In accordance with embodiments of the present invention, the packet capture library taps into the TCP stack of the sending system to monitor the available window size below the TCP driver. Standard system calls transmit each data packet from each TCP connection class 160 to the network stack and TCP driver, which then transmits the data packets to the network, Internet, etc. In one embodiment of the invention, packet capture library evaluates each data packet, and specifically the available window size of each data packet, after the TCP connection class 160 and the TCP driver when sending data packets. By examining the data packets using the packet capture library, embodiments of the present invention calculate the available window sizes for each TCP connection class 160 using the SEQ and ACK fields in each data packet according to standard TCP protocol and as described above. In this manner, packet capture library can monitor the available window size of the data packets of each TCP connection class 160. The available window size, then, is used to calculate the queue that develops for each of the plurality of TCP connection classes 160. In one embodiment, a small and a decreasing available window size indicates a growing queue. Monitor module 162, in one embodiment, evaluates the queue for each of the plurality of TCP connection classes 160, provides the queue information to the packet sender module 156, which then sends packets to the TCP connection class 162 having the smallest queue.

FIG. 5 illustrates the function of packet capture library 164 in accordance with one embodiment of the present invention. Each of the plurality of TCP connection classes 160 sends data packets to the network stack where the TCP driver 166 transmits the data packets to the Internet 168. Packet capture library (PCap Library) 164 taps into the network stack to obtain the available window size for each data packet from each TCP connection class 160. In one embodiment of the invention, the available window size obtained is for each of the plurality of TCP connection classes 160 and thereby a measure of the queue is provided for each of the plurality of TCP connection classes 160. Monitor module 162 (see FIG. 4) is then able to monitor the available window size or queue for each of the plurality of TCP connection classes, and provide the information to the packet sender module 156 (see FIG. 4) which can then send each data packet to the TCP connection class 160 with the smallest queue.

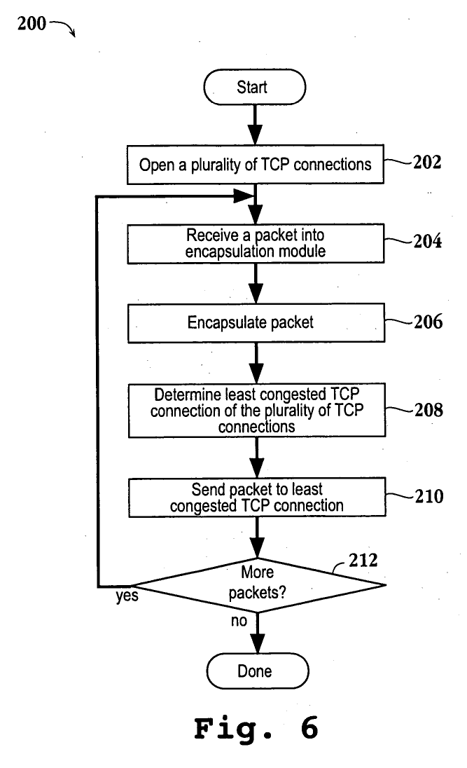

FIG. 6 is a flow chart diagram 200 illustrating the method operations for data transmission utilizing multiple TCP channels in accordance with one embodiment of the present invention. The method begins with operation 202 in which a plurality of TCP connections are opened. In one embodiment of the invention, the sender application opens a plurality of TCP connection classes, providing a plurality of TCP connections for transmitting data. TCP connection classes are opened in accordance with known programming operations used to open a single TCP connection.

The method continues with operation 204 in which a data packet is received into an encapsulation module, and then in operation 206 the received data packet is encapsulated as a TCP data packet. In one embodiment, the encapsulation module appends a standard, stateful TCP header to data packets for transmission. Data packets typically transmitted as UDP packets are encapsulated with a standard TCP header to effectively create a TCP packet for transmission having UDP data. In one embodiment, a corresponding module on the receiver side will unpack the data packet to process the data as UDP after transmission processing according to TCP protocol.

In operation 208 the plurality of TCP connections are evaluated to determine the least congested TCP connection of the plurality of connections. In one embodiment, the least congested TCP connection is the TCP connection with the largest available window size. As described above, available window size is used to evaluate the queue of data packets being transmitted by each of the plurality of TCP connections. In one embodiment, a first transmission will indicate an “empty queue,” that is, no packets in transmission, awaiting acknowledgement, etc. In this situation, one embodiment of the present invention provides for a sequential or “round robin” assignment of data packets to each of the plurality of TCP connections. In another embodiment, if queue size for each of the plurality of TCP connections is determined to be identical, data packets are assigned sequentially or round robin. In typical situations, however, data packets are assigned to the connection class with the largest available window size, or smallest queue, which suggests the least congested TCP connection.

In another embodiment of the present invention, congestion feedback for network traffic, such as data packets transmitted by a video conferencing application, is provided by a network router. One example is ICMP (Internet Control Message Protocol) packets sent by routers in the path of the packets. The discussion of the ICMP protocol is beyond the scope of this disclosure.

In operation 210, the data packet is sent to the least congested TCP connection for transmission.

The method next proceeds with decision block 212 in which it is determined whether there are more data packets. Decision block 212 creates the loop in the method for the transmission of all data packets. So long as data packets continue to be provided for transmission, a “yes” to decision block 212, the method loops back to operation 204 in which the data packets are received into the encapsulation module for processing as described. At the completion of data transmission when no data packets remain, a “no” to decision block 212, the method is done.

Embodiments of the present invention implement standard programming to create a plurality of TCP connections by the sender application, to monitor the available window size of each of the plurality of TCP connections, and to send data packets to the TCP connection having the largest available window size. As is known, wide variations of programming language, operations, and methods can be implemented to achieve a same result. Exemplary programming algorithms are provided to illustrate an embodiment of the invention, and should not be interpreted to be limiting or exclusive. In one embodiment, an algorithm to implement the present invention is a SendPacket Function:

```
/**
* This function sends a packet to the packet sender module
**/
void SendPacket(Packet pkt) {
  // Get the connection with the maximum available window
  connection = GetLeastCongestedConnection(Connection
Array);
  connection.sendPacket(pkt);
}
/** This function returns the connection that is least
congested **/
Connection GetLeastCongestedConnection(Connection Array) {
  int max = −1;
  Connection con = null;
  for (each connection tcp_con in the Connection Array) {
    if (max < tcp_con.getAvailableWindowSize( )) {
      max = tcp_con.getAvailableWindowSize( );
      con = tcp_con;
    }
  }
  return con;
}
```

In one embodiment, an algorithm to implement the present invention is a Packet Monitor:

```
for each packet coming from the sender {
  // Gets the connection where the packet is coming from
  connection = GetConnection(packet);
  connection.send_seq = packet.sequence_number;
}
for each packet coming from the network {
  if (packet's ACK flag is turned on) {
    // Gets the connection where is packet is being
    // delivered to
    connection = GetConnection(packet);
    connection.ack_seq;
  }
}
```

In one embodiment, an algorithm to implement the present invention is a Connection Class:

```
  Connection GetAvailableWindowSize( ) {
    return WindowSize − distance of send_seq and
ack_seq;
  }
```

As described above, embodiments of the present invention can be implemented to extend the method and system described in co-pending U.S. patent application Ser. No. 10/990,274, to provide for multiple TCP connections which are fully TCP compliant. In one embodiment of the present invention, a fully TCP compliant tunneling TCP connection having multiple TCP connections can be implemented according to the following operations:
When the sender module is launched, executed, or otherwise activated, multiple logical TCP connections are established by sending several SYN and SYN+ACK packets.
When the sender application transmits a packet, it will send the packet to the logical TCP connection that has the smallest window size. Each packet is first encapsulated as described for embodiments of the present invention, but the TCP header used is the modified or inventive TCP header described in co-pending
U.S. patent application Ser. No. 10/990,274. The receiver never sends the RESEND request to the sender. The RESEND request is usually sent by the receiver to the sender to request the resend of a packet in a regular TCP implementation.
The receiver constantly piggyback the ACK flag to the PUSH packets. However, not every sequence number is acknowledged, but the latest sequence number is acknowledged.
No congestion control is implemented.

In summary, embodiments of the present invention provide for deployment of multiple TCP connections with congestion feedback, ideally suited for delivery of audio and video streams. A sender application opens multiple TCP connections and encapsulates all data packets for transmission as TCP data packets. A packet capture library monitors packet activity beneath the TCP driver stack to determine the available window size for data packet transmission at each of the plurality of TCP connections. A monitor module provides the queue information to a packet sender module, which assigns data packets for transmission to the least congested of the plurality of TCP connections. When the sender has a packet to send, it will look at its available TCP connections and pick the one with the maximum TCP available window size. In this way, if a packet is lost during packet delivery, the later packets will not be stalled. They will arrive at the other TCP connections. The chance for all the TCP connections to stall is very small.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer, readable medium. The computer readable medium is any data storage device that can store data, which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method of transmitting data over a communication network, comprising:
opening a plurality of Transmission Control Protocol (TCP) connections, each of the plurality of TCP connections being opened by an application having data to transmit;
forming data packets to transmit the data;
appending a TCP header to a data packet;
selecting one of the plurality of TCP connections for transmitting the data packet, and
transmitting the data packet over the selected one of the plurality of TCP connections.

2. The method of claim 1, further comprising:
monitoring each of the plurality of TCP connections to determine a queue of data to be transmitted over each of the plurality of TCP connections.

3. The method of claim 1, wherein the data to transmit includes audio data and video data.

4. The method of claim 1, wherein the transmitting is according to TCP protocol over the selected one of the plurality of TCP connections.

5. The method of claim 2, wherein the selecting of the one of the plurality of TCP connections for transmitting the data includes the selecting of the one of the plurality of TCP connections having a smallest queue.

6. The method of claim 2, wherein the queue of data to be transmitted is determined by examining an available window size for each data packet transmitted through each one of the plurality of TCP connections.

7. The method of claim 2, wherein the queue of data to be transmitted over each of the plurality of TCP connections is determined by examining an available window size for each data packet transmitted through each one of the plurality of TCP connections, the available window size being examined by intercepting each data packet in a network stack below a TCP driver.

8. The method of claim 2, wherein the queue of data to be transmitted is a measure of congestion of each one of the plurality of TCP connections.

9. A method of processing data for transmission over a data network, comprising:
opening a plurality of Transmission Control Protocol (TCP) connections for transmitting data;
forming a plurality of initial data packets of data to be transmitted over the data network;
encapsulating each one of the plurality of initial data packets with a TCP header, the plurality of encapsulated initial data packets being a plurality of transmission data packets;
selecting one of the plurality of TCP connections for transmitting data for each one of the plurality of transmission data packets;
sending each one of the plurality of transmission data packets through its selected one of the plurality of TCP connections to a network driver for transmission over the data network; and
examining each one of the plurality of transmission data packets to determine a state of congestion of each one of the plurality of TCP connections.

10. The method of claim 9, further comprising:
intercepting each on of the plurality of transmission data packets in a network stack prior to the network driver; and.
determining an available window size for each one of the plurality of transmission data packets,
wherein the determined available window size reflects the state of congestion of each one of the plurality of TCP connections.

11. The method of claim 9, wherein when selecting one of the plurality of TCP connections for transmitting data for each one of the plurality of transmission data packets, a least congested one of the plurality of TCP connections is selected.

12. A medium or waveform containing a computer-readable set of instructions adapted to perform the method of claim 1.

13. A medium or waveform containing a computer-readable set of instructions adapted to perform the method of claim 2.

14. A medium or waveform containing a computer-readable set of instructions adapted to perform the method of claim 5.

15. A medium or waveform containing a computer-readable set of instructions adapted to perform the method of claim 7.

16. An integrated circuit chip for establishing data exchange between computing systems, comprising:
logic configured to open a plurality of Transmission Control Protocol (TCP) connections for transmitting data packets;
logic configured to form data packets for transmission, the data packets formed for transmission containing audio data and video data;
logic configured to append TCP headers to the data packets;
logic configured to select one of the plurality of TCP connections for transmitting a data packet having an appended TCP header; and
logic configured to transmit the data packet having the appended TCP header over the selected one of the plurality of TCP connections.

17. The integrated circuit chip of claim 16, further comprising:
logic configured to determine a congestion of each one of the plurality of TCP connections for transmitting data packets; and
logic configured to select a least congested one of the plurality of TCP connections for transmitting data packets.

18. The integrated circuit chip of claim 17, wherein the congestion of each one of the plurality of TCP connections is determined by determining an available window size of data packets being transmitted by each one of the plurality of TCP connections.

19. The integrated circuit chip of claim 16, wherein the transmitting of the data packet having the appended TCP header over the selected one of the plurality of TCP connections is according to TCP protocol.

20. The integrated circuit chip of claim 18, wherein the available window size of data packets being transmitted by each one of the plurality of TCP connections is determined by examining the data packet having the appended TCP header in a network stack below a TCP driver.
